(19) United States
(12) Patent Application Publication
(10) Pub. No.: US 2017/0370400 A1
(43) Pub. Date: Dec. 28, 2017

(54) Fastener for Corrugated Sheet

(71) Applicant: San-He Chang, Taipei City (TW)

(72) Inventor: San-He Chang, Taipei City (TW)

(21) Appl. No.: 15/190,265

(22) Filed: Jun. 23, 2016

(51) Int. Cl. F16B 43/00; E04D 3/36; F16B 35/00; F16B 39/24

(52) U.S. Cl. CPC F16B 43/001; F16B 39/24; E04D 3/3606; F16B 35/00

(57) ABSTRACT

A fastener for a corrugated sheet includes at least one support on a top of the corrugated sheet; at least one steel member on a bottom of the corrugated sheet; a cylindrical assembly including elongated, plate shaped fastening members assembled as a hollow cylinder, each fastening member tapered to one end to form a hook and having a curved groove on an outer surface, and a curved trough on the outer surface at the other end, the curved troughs assembled to form an annular recess; a retainer ring secured to the annular recess; and a ring-shaped elastic member secured to the curved groove; a threaded bolt driven through the retainer ring, the fastening members, the support, and the corrugated sheet into the steel member; an expansion nut moveably secured to the threaded bolt; and a ring-shaped first sealing member fastened between the support and the corrugated sheet.

### BACKGROUND OF THE INVENTION

### 1. Field of the Invention

The invention relates to fastening of corrugated sheets and more particularly to a fastener for a corrugated sheet having a sealing member fastened between a support and a corrugated sheet so that a fastened structure can be waterproof, moreover, splayed hooks fastened in a steel member capable of greatly increasing the structural strength of both the support and the corrugated sheet, thereby withstanding heavy rain and winds.

### 2. Description of Related Art

Many patios, factories and buildings have corrugated sheet roofs. A corrugated sheet roof has the functions of preventing rain from entering the building, preventing sunlight from directly entering the building, and being a heat barrier. The corrugated sheet roofs are easy to construct and inexpensive. Typically, a corrugated sheet and a structure attached thereto are fastened by threaded fasteners (e.g., screws). Only the threaded shank of the screw is through the corrugated sheet and thus it is not sufficiently secure. It is possible that in clement weather rain may enter the building through the joining portion of the screw and the corrugated sheet. To the worse, strong winds may blow the corrugated sheet away to not only damage the building but also hurt or even kill people.

Thus, the need for improvement exists.

### SUMMARY OF THE INVENTION

It is therefore one object of the invention to provide a fastener for a corrugated sheet comprising a corrugated sheet including a plurality of through holes; at least one support mounted on a top of the corrugated sheet; at least one steel member mounted on a bottom of the corrugated sheet; a cylindrical assembly including a plurality of elongated, plate shaped fastening members assembled as a hollow cylinder, each fastening member tapered to one end to form a hook at one end and having a curved groove on an outer surface, and a curved trough on the outer surface at the other end of the fastening member, the curved troughs assembled to form an annular recess; a retainer ring secured to the annular recess; a ring-shaped elastic member secured to the curved groove; and a washer; a threaded bolt driven through the washer, the retainer ring, the fastening members, the support, and the corrugated sheet into the steel member; an expansion nut having a multi-sided outer surface and moveably secured to the threaded bolt; and a ring-shaped first sealing member fastened between and by the support and the corrugated sheet and disposed on each through hole; wherein the threaded bolt is secured to the expansion nut which is surrounded by the hooks prior to driving through the support.

Preferably, the expansion nut includes a plurality of spaced flats and a plurality of raised portions each between two adjacent flats, the expansion nut tapered to one end facing the retainer ring.

Preferably, further comprises a second sealing member fastened below the washer, and a sleeve mounted between the second sealing member and the retainer ring, and wherein one end of the sleeve urges against the retainer ring and the other end thereof urges against the second sealing member.

Preferably, the corrugated sheet further includes a plurality of top risers disposed under the support, and wherein the through holes are disposed through the top risers respectively.

Preferably, the steel member has a longitudinal section of C, H, L, or circle.

Preferably, the support includes an upright extending mount configured to threadedly secure to a sheet member.

Preferably, the first sealing member is a pad made of thermoplastic.

The above and other objects, features and advantages of the invention will become apparent from the following detailed description taken with the accompanying drawings.

### BRIEF DESCRIPTION OF THE DRAWINGS

FIG. 1 is a perspective view of a fastener for corrugated sheet according to a first preferred embodiment of the invention;

FIG. 2 is an exploded view of the fastener;

FIG. 3 is an exploded, longitudinal sectional view of the fastener;

FIG. 4 is a longitudinal sectional view of the assembled fastener;

FIG. 4A is a sectional view taken along line A-A of FIG. 4;

FIG. 5 is a longitudinal sectional view of a fastener according to a second preferred embodiment of the invention;

FIG. 5A is a perspective view of the sleeve;

FIG. 6 is an exploded, longitudinal sectional view of the fastener, a support, the first sealing member, a corrugated sheet, and a steel member to be assembled;

FIG. 7 is a longitudinal sectional view of the assembled fastener, the support, the first sealing member, the corrugated sheet, and the steel member; and

FIG. 8 is a view similar to FIG. 7 showing the fastener mounted on a roof made of corrugated sheet, the fastener being expanded, and further secured to a sheet member.

### DETAILED DESCRIPTION OF THE INVENTION

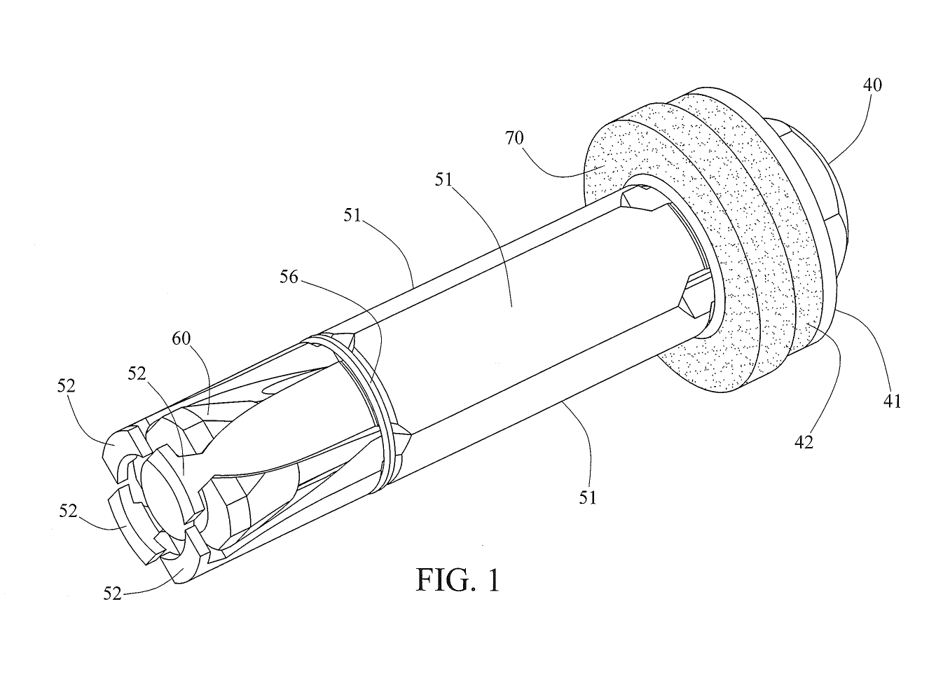

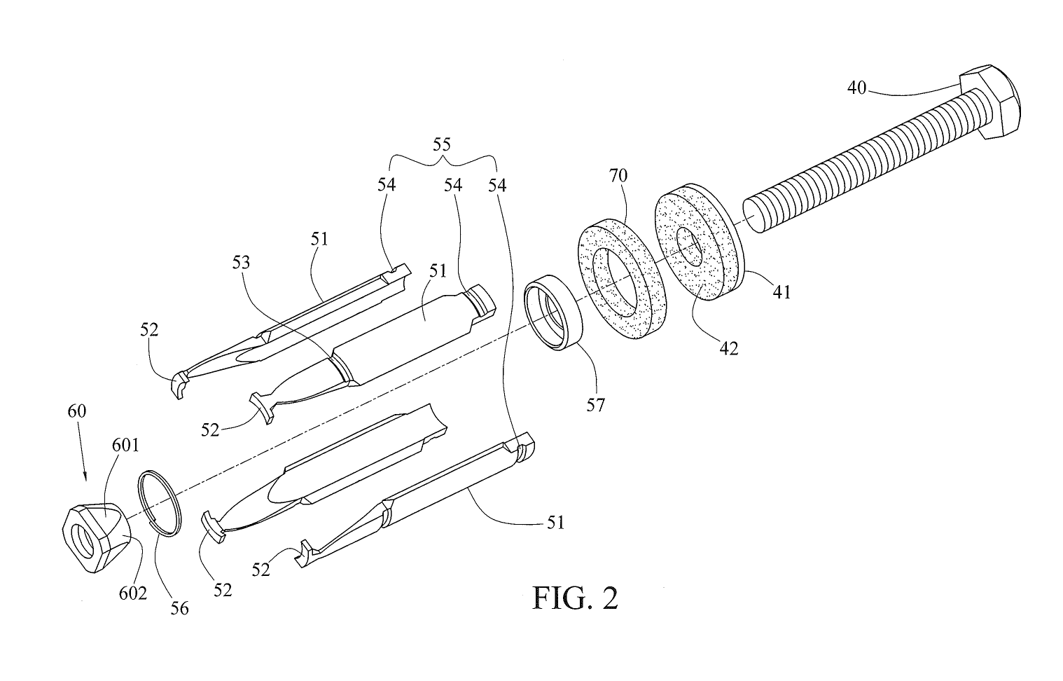

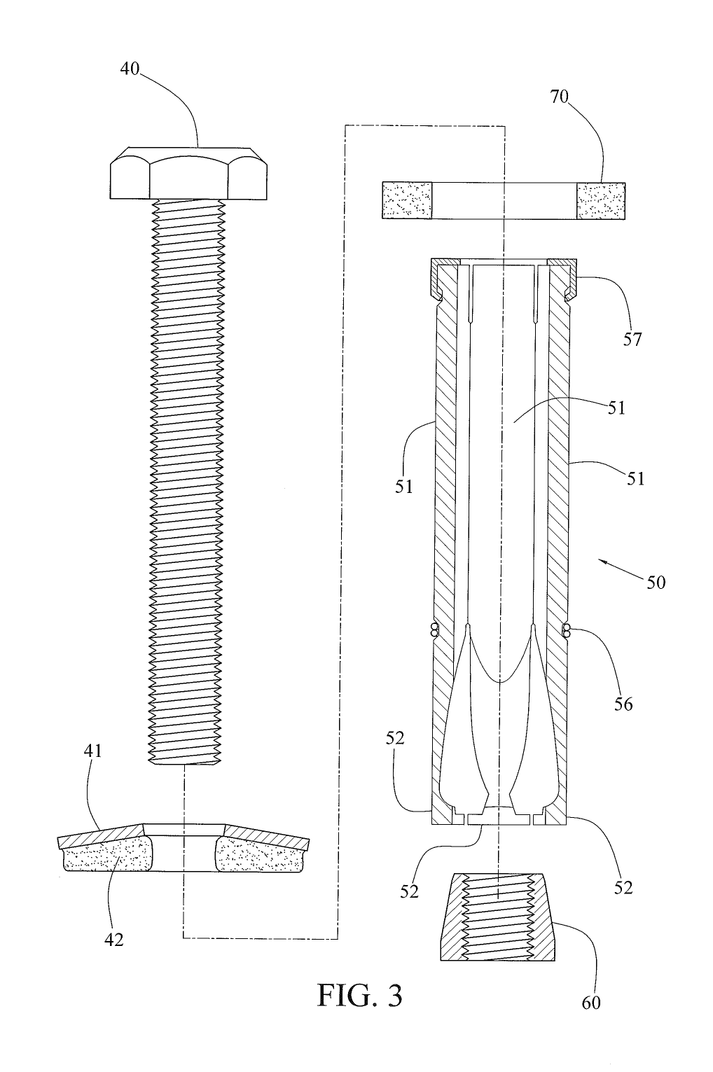

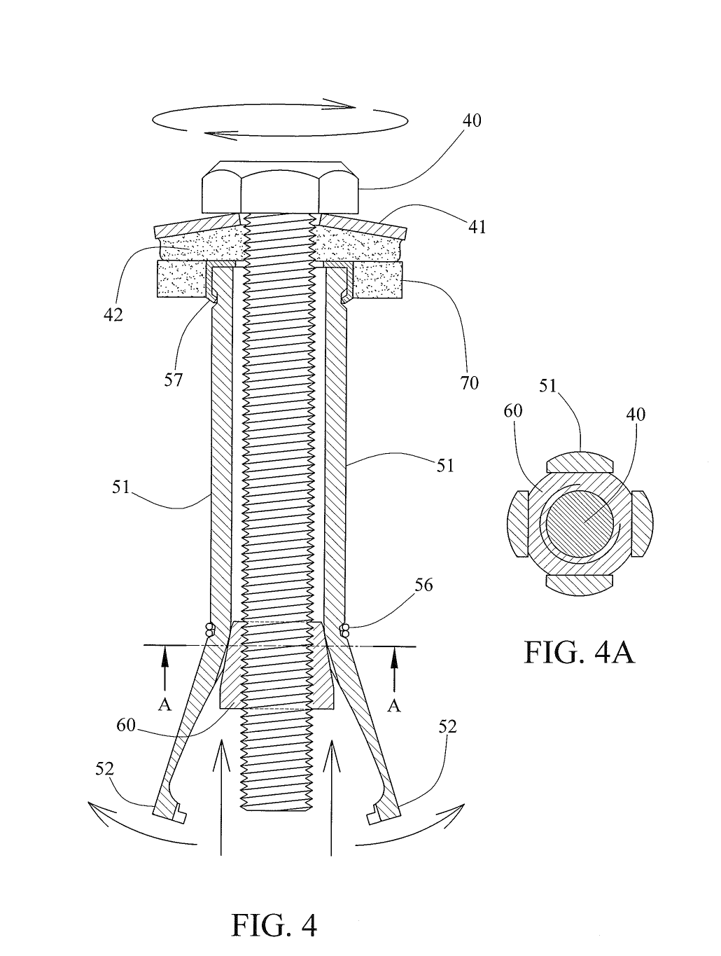

Referring to FIGS. 1 to 4, a fastener for corrugated sheet in accordance with a first preferred embodiment of the invention comprises the following components as discussed in detail below.

A cylindrical assembly 50 includes a plurality of elongated, plate shaped fastening members 51 assembled as a hollow cylinder, the fastening member 51 tapered to one end to form a hook 52 at one end and having a curved groove 53 on an outer surface adjacent to the position that the fastening member 51 tapers, and a curved trough 54 on the outer surface at the other end of the fastening member 51, the curved troughs 54 assembled to form an annular recess 55; a retainer ring 57 secured to the annular recess 55; and a ring-shaped elastic member 56 secured to the curved groove 53.

There are further provided with a first sealing member 70 put on a peripheral surface of the retainer ring 57; a second sealing member 42 disposed on the first sealing member 70; a washer 41 disposed on the second sealing member 42; a threaded bolt 40 driven through the washer 41, the second sealing member 42, the retainer ring 57, and the fastening member 51 to have an open end proximate to the hooks 52; and an expansion nut 60 having a multi-sided outer surface and moveably secured to the bolt 40. The expansion nut 60 is surrounded by the hooks 52.

The expansion nut 60 includes a plurality of spaced flats 601 and a plurality of raised portions 602 each between two adjacent flats 601. The expansion nut 60 tapers to one end facing the retainer ring 57.

A person may threadedly move the expansion nut 60 along the threads of the bolt 40 by splaying the hooks 52 apart until the expansion nut 60 is disposed at a position proximate to the elastic member 56 with the raised portions 602 urging against an inner surface of the fastening member 51. As a result, the fastening member 51 is fastened.

Preferably, both the first and second sealing members 70, 42 are made of a waterproof material to prevent water from entering the fastening member 51 through the retaining ring 30. Otherwise, the fastener may be rusted.

Preferably, both the first and second sealing members 70, 42 are shaped as a ring and implemented as a pad made of thermoplastic.

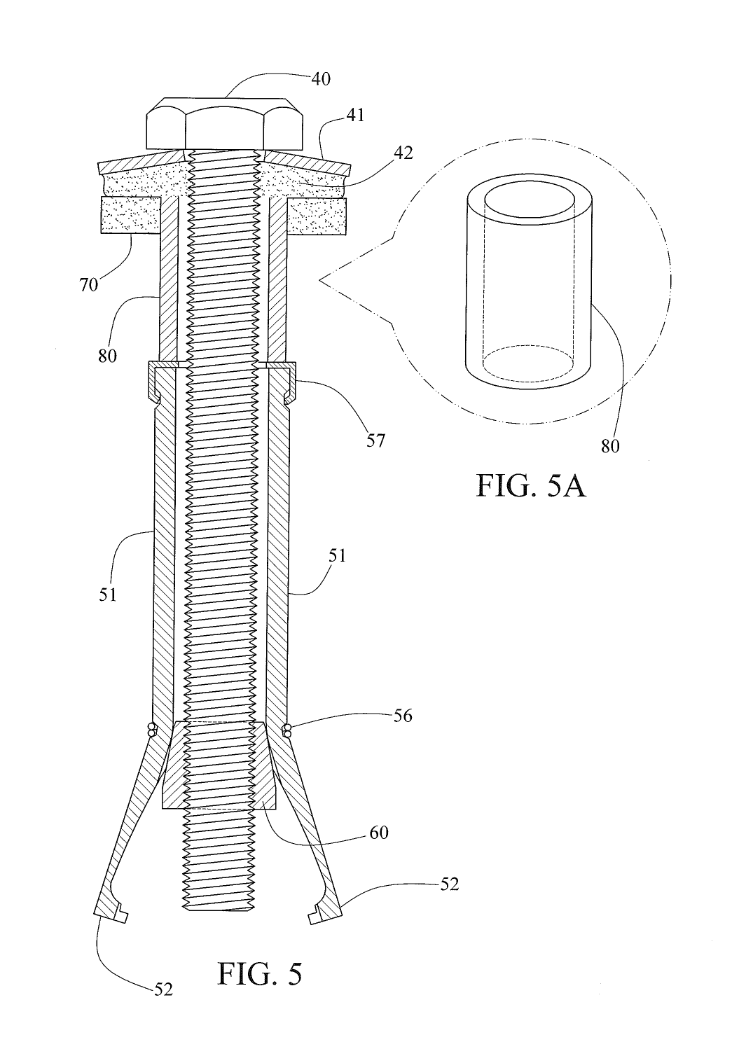

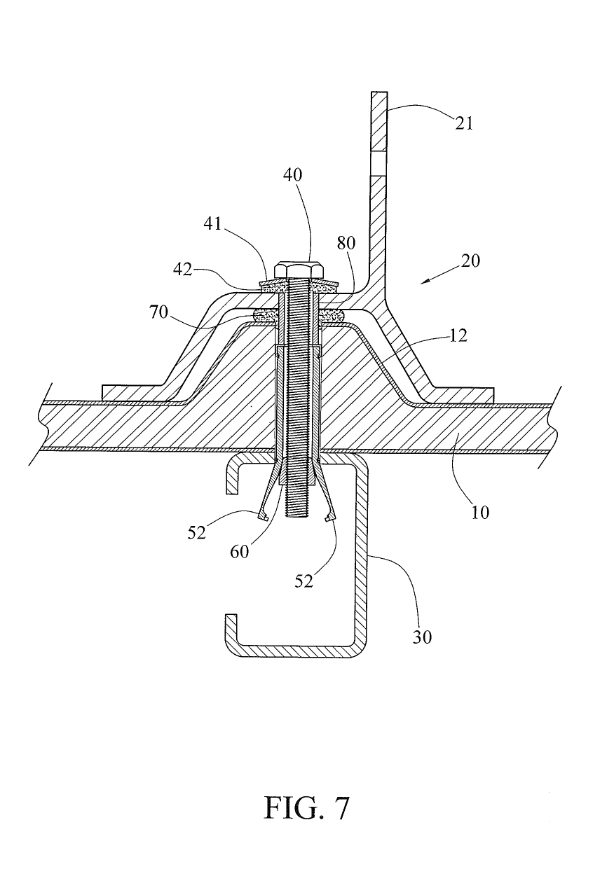

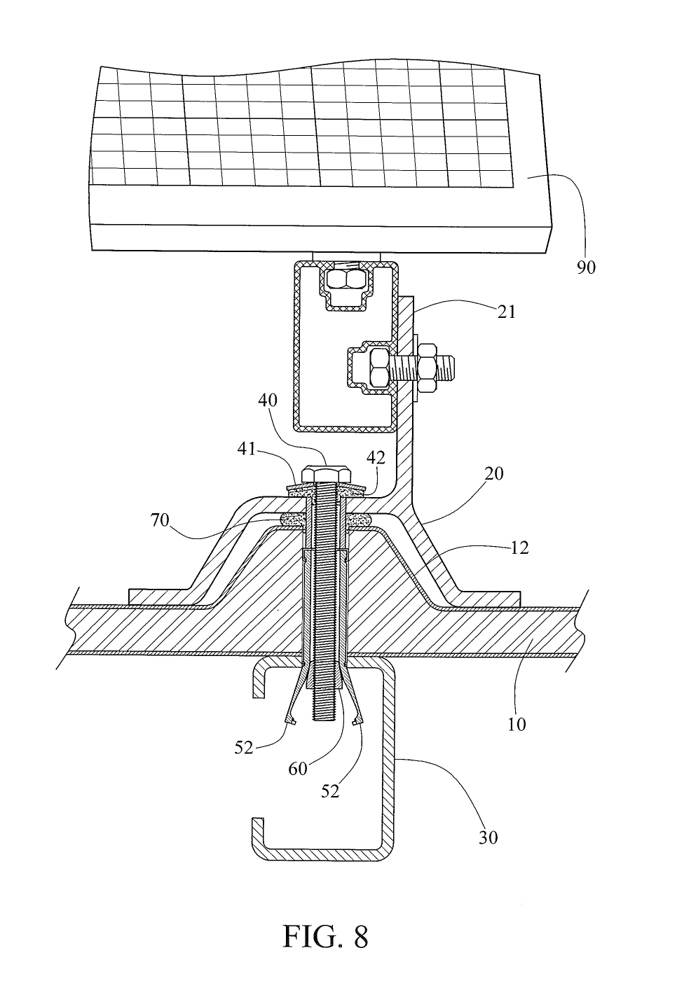

Referring to FIGS. 5 to 8, a fastener for corrugated sheet in accordance with a second preferred embodiment of the invention is shown. The characteristics of the second preferred embodiment are substantially the same as that of the first preferred embodiment except the following:

A sleeve 80 is mounted between the second sealing member 42 and the retainer ring 57. That is, one end of the sleeve 80 urges against the retainer ring 57 and the other end thereof urges against the second sealing member 42.

Referring to FIGS. 1 to 8 again, in a fastening operation, a person may drive the threaded bolt 40 through the washer 41, the second sealing member 42, the sleeve 80, the retainer ring 57, the fastening member 51, a support 20, the first sealing member 70, a corrugated sheet 10, and a steel member 30 to have an open end proximate to the hooks 52; and next threadedly move the expansion nut 60 along the threads of the bolt 40 by splaying the hooks 52 apart until the expansion nut 60 is disposed at a position proximate to the elastic member 56 with the raised portions 602 urging against an inner surface of the fastening member 51. As a result, the fastener, the support 20, the corrugated sheet 10, and the steel member 30 are fastened together.

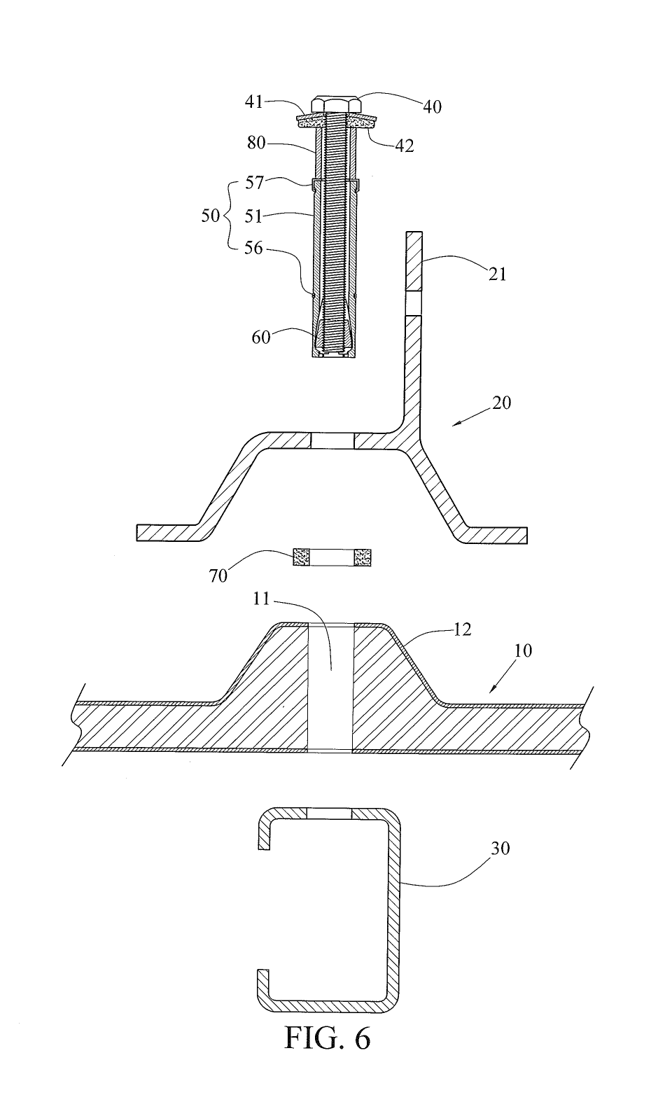

The support 20 includes an upright extending mount 21 configured to threadedly secure to a sheet member 90. The corrugated sheet 10 includes a plurality of top risers 12 (only one shown in the figures) disposed under the support 20 and a plurality of through holes 11 each through the top riser 12. The steel member 30 has a longitudinal section of C (as shown in FIG. 6), H, L or circle.

Preferably, a bottom of the corrugated sheet 10 is fastened on the steel member 30, a top thereof is secured to the support 20, and the first sealing member 70 is fastened between and by the support 20 and the top riser 12.

Prior to fastening, positions of the support 20, the corrugated sheet 10 and the steel member 30 to be drilled should be chosen. Thereafter, in a next fastening operation the cylindrical assembly 50 can be driven through the support 20, the corrugated sheet 10 and the steel member 30. Also, the first sealing member 70 is clamped by and between the support 20 and the corrugated sheet 10. Next, the threaded bolt 40 is driven through the second sealing member 42 into the cylindrical assembly 50 and threadedly move the expansion nut 60 along the threads of the bolt 40 by splaying the hooks 52 apart by bending the fastening member 51 at the curved grooves 53 and expanding the elastic member 56 until the expansion nut 60 is disposed at a position proximate to the elastic member 56 with the raised portions 602 urging against an inner surface of the fastening member 51. Finally, the support 20 is threadedly secured to a structure, for example, a cooling tower, a water tank, a solar panel, or a satellite dish. As a result, the fastening operation is completed.

The provision of the sleeve 80 between the second sealing member 42 and the retainer ring 57 allows the fastener to secure to a structure having a greater thickness. Also, the first sealing member 70 is put on the sleeve 80.

It is noted that the first sealing member 70 is fastened between the support 20 and the corrugated sheet 10 so that the fastened structure can be waterproof. Moreover, the splayed hooks 52 fastened in the steel member 30 can greatly increase the structural strength of both the support 20 and the corrugated sheet 10. Thus, persons and equipment in a building can be protected. Also, the building can withstand heavy rain and winds.

While the invention has been described in terms of preferred embodiments, those skilled in the art will recognize that the invention can be practiced with modifications within the spirit and scope of the appended claims.

What is claimed is:

1. A fastener for a corrugated sheet comprising:
a corrugated sheet including a plurality of through holes;
at least one support mounted on a top of the corrugated sheet;
at least one steel member mounted on a bottom of the corrugated sheet;
a cylindrical assembly including a plurality of elongated, plate shaped fastening members assembled as a hollow cylinder, each fastening member tapered to one end to form a hook at one end and having a curved groove on an outer surface, and a curved trough on the outer surface at the other end of the fastening member, the curved troughs assembled to form an annular recess; a retainer ring secured to the annular recess; a ring-shaped elastic member secured to the curved groove; and a washer;
a threaded bolt driven through the washer, the retainer ring, the fastening members, the support, and the corrugated sheet into the steel member;
an expansion nut having a multi-sided outer surface and moveably secured to the threaded bolt; and
a ring-shaped first sealing member fastened between and by the support and the corrugated sheet and disposed on each through hole;
wherein the threaded bolt is secured to the expansion nut which is surrounded by the hooks prior to driving through the support.

2. The fastener of claim 1, wherein the expansion nut includes a plurality spaced flats and a plurality of raised portions each between two adjacent flats, the expansion nut tapered to one end facing the retainer ring.

3. The fastener of claim 1, further comprising a second sealing member fastened below the washer, and a sleeve mounted between the second sealing member and the retainer ring, and wherein one end of the sleeve urges against the retainer ring and the other end thereof urges against the second sealing member.

4. The fastener of claim 1, wherein the corrugated sheet further includes a plurality of top risers disposed under the support, and wherein the through holes are disposed through the top risers respectively.

5. The fastener of claim 1, wherein the steel member has a longitudinal section of C, H, L, or circle.

6. The fastener of claim 1, wherein the support includes an upright extending mount configured to threadedly secure to a sheet member.

7. The fastener of claim 1, wherein the first sealing member is a pad made of thermoplastic.
